(19) United States
(12) Patent Application Publication
(10) Pub. No.: US 2025/0239426 A1
(43) Pub. Date: Jul. 24, 2025

(54) FUSE UNIT

(71) Applicant: SUBARU CORPORATION, Tokyo (JP)

(72) Inventor: Gentaro NAKAOKA, Tokyo (JP)

(73) Assignee: SUBARU CORPORATION, Tokyo (JP)

(21) Appl. No.: 19/173,605

(22) Filed: Apr. 8, 2025

Related U.S. Application Data
(63) Continuation of application No. PCT/JP2023/033320, filed on Sep. 13, 2023.

(51) Int. Cl. H01H 39/00; H01H 71/02

(52) U.S. Cl. CPC H01H 39/006; H01H 71/0214; H01H 2039/008; H01H 2231/026; H01H 2235/01

(57) ABSTRACT

A fuse unit includes: a bus bar made of a conductor and provided with a cuttable portion; a case body supporting two points sandwiching the cuttable portion; a cutting portion made of an insulator and disposed in a first space in an internal space of the case body on one side with respect to the bus bar; and a reconnecting portion made of a conductor and disposed in a second space in the internal space on a side of the bus bar opposite to the first space. The cutting portion includes a tip portion that cuts the bus bar into a first portion and a second portion at the cuttable portion. The tip portion is movable into the second space. The reconnecting portion includes a first connecting portion in contact with the first portion and a second connecting portion in contact with the second portion.

### CROSS-REFERENCE TO RELATED APPLICATIONS

This application is continuation of International Application No. PCT/JP2023/033320, filed on Sep. 13, 2023, the entire contents of which are hereby incorporated by reference.

### TECHNICAL FIELD

The disclosure relates to the technical field of a fuse unit.

### BACKGROUND

There is known a fuse unit that breaks electrical connection in order to ensure safety when an abnormality occurs.

For example, in a vehicle having a high-voltage in-vehicle battery, a fuse unit is used to stop power supply from the in-vehicle battery when an accident occurs.

The Japanese Unexamined Patent Application Publication No. 2022-45414 discloses a configuration in which a fusible part of a fusible part unit is fused to break an electric circuit, thereby protecting various electrical components and the electric circuit.

### SUMMARY

An aspect of the disclosure provides a fuse unit. The fuse unit includes a bus bar, a case body, a cutting portion, and a reconnecting portion. The bus bar is made of a conductor and provided with a cuttable portion. The case body supports two points sandwiching the cuttable portion. The cutting portion is made of an insulator and disposed in a first space. The first space is provided in an internal space of the case body on one side with respect to the bus bar. The reconnecting portion is made of a conductor and disposed in a second space. The second space is provided in the internal space of the case body on a side of the bus bar opposite to the first space. The cutting portion includes a tip portion that cuts the bus bar into a first portion and a second portion at the cuttable portion. The tip portion is movable into the second space. The reconnecting portion includes a first connecting portion in contact with the first portion and a second connecting portion in contact with the second portion.

### BRIEF DESCRIPTION OF THE DRAWINGS

The accompanying drawings are included to provide a further understanding of the disclosure, and are incorporated in and constitute a part of this specification. The drawings illustrate an embodiment and, together with the specification, serve to explain the principles of the disclosure.

FIG. 1 is a schematic cross-sectional view illustrating a configuration example of a fuse unit according to an embodiment of the disclosure.

FIG. 2 is an enlarged schematic perspective view illustrating a cutting tip portion and a bus bar of the fuse unit.

FIG. 3 is a schematic view illustrating a state in which the bus bar is divided into a first portion and a second portion.

FIG. 4 is a schematic cross-sectional view illustrating an example of a disconnection state of the fuse unit.

FIG. 5 is a schematic cross-sectional view illustrating another example of the disconnection state of the fuse unit, and is a view illustrating a state in which both tip portions of the first portion and the second portion are in contact with an insulating portion.

FIG. 6 is a schematic cross-sectional view illustrating an example of a reconnection state of the fuse unit.

FIG. 7 is a schematic cross-sectional view illustrating an example of a fuse unit according to a first modification.

FIG. 8 is a schematic cross-sectional view illustrating an example of a normal state of a fuse unit of a second modification.

FIG. 9 is a schematic cross-sectional view illustrating an example of a reconnection state of a fuse unit according to a second modification.

FIG. 10 is a schematic cross-sectional view illustrating a part of an example of a fuse unit of a third modification.

### DETAILED DESCRIPTION

After an electrical connection is released by a fuse unit, there is a case where the electrical connection is desired to be temporarily restored. For example, in a fuse unit mounted on a vehicle, when an accident occurs, the fuse unit operates to break power supply from an in-vehicle battery, thereby ensuring the safety of an occupant.

However, there is a case where it is dangerous to leave the accident vehicle as it is at the accident site, and it is preferable to move the accident vehicle to a safe place before a wrecker arrives.

In such a case, it is desirable to temporarily restore the electrical connection cut off by the fuse unit.

It is desirable is to provide a fuse unit that can release and recover electrical connection with a simple configuration.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Configuration of Fuse Unit

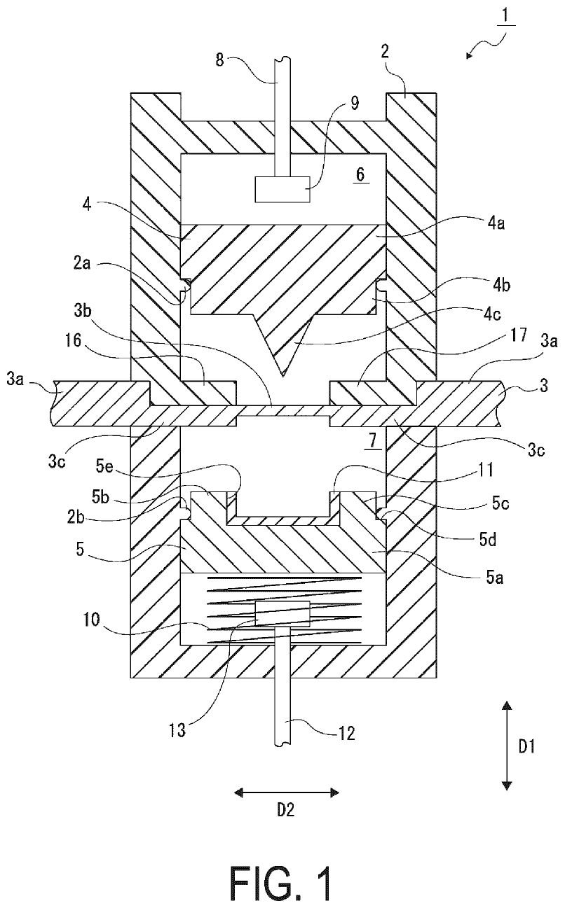

FIG. 1 illustrates a configuration example of the fuse unit 1 according to the disclosure.

The fuse unit 1 is used to cut off the electrical connection on the upstream side closer to the power source, thereby protecting each part disposed on the downstream side and reducing the influence on the human body.

For example, in an example of application to a vehicle, the fuse unit 1 may be provided in the vicinity of an in-vehicle battery or in the vicinity of an electronic control unit (ECU) or the like to be protected.

The fuse unit 1 includes a case body 2 in which a space is formed, a bus bar 3 made of a conductor, a cutting portion 4 for cutting the bus bar 3, and a reconnecting portion 5 for recovering electrical connection after the bus bar 3 is cut.

The case body 2 is made of an insulator, and the bus bar 3 is disposed in the vicinity of substantially the center of the internal space of the case body 2. A first space 6 formed on one side with respect to the bus bar 3 and a second space 7 formed on the opposite side to the first space 6 with respect to the bus bar 3 are provided inside the case body 2.

In the following description, a direction in which the first space 6 and the second space 7 are arranged is referred to as a vertical direction D1. A plane perpendicular to the vertical direction D1 is described as a horizontal plane.

However, the horizontal plane for description does not need to be orthogonal to the gravity direction when the fuse unit 1 is actually attached.

A direction in which the bus bar 3 extends inside the fuse unit 1 is referred to as a left-right direction D2, and a direction orthogonal to the vertical direction D1 and the left-right direction D2 is referred to as a front-rear direction D3.

Of course, the left-right direction D2 and the front-rear direction D3 in the description are also for convenience of description, and the mounting direction when implementing the fuse unit 1 is not limited to these directions.

Each of the first space 6 and the second space 7 may be a cylindrical space, a cubic space, or any other space. In the following description, an example in which each of the first space 6 and the second space 7 is a cylindrical space will be described.

The cutting portion 4 is disposed in the first space 6. The cutting portion 4 includes a large-diameter portion 4a having substantially the same size as the cross section of the first space 6, a small-diameter portion 4b continuing downward from the large-diameter portion 4a, and a cutting tip portion 4c protruding downward from the center of the small-diameter portion 4b.

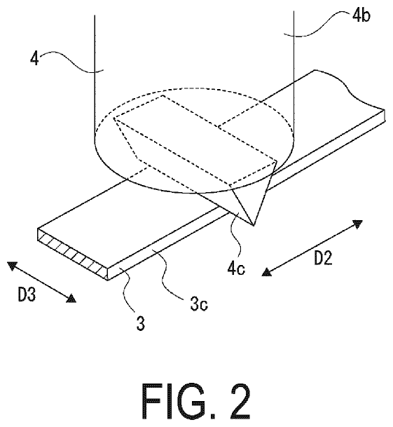

As illustrated in FIG. 2, the cutting tip portion 4c is in the shape of a triangular column whose axial direction is the front-rear direction D3, and the widths of the left-right direction D2 decrease toward the bottom.

In the case body 2, a support protruding portion 2a is formed in the vicinity of substantially the center of the vertical direction D1 on the inner peripheral surface of the first space 6.

Support protruding portions 2a may be provided so as to be spaced apart from each other in the circumferential direction on the inner surface of the first space 6, or may be provided in an annular shape without interruption in the circumferential direction.

The cutting portion 4 is maintained in a state of being located in the middle of the vertical direction D1 in the first space 6 by the step at the boundary portion between the large-diameter portion 4a and the small-diameter portion 4b being supported from below by the support protruding portion 2a.

The first space 6 is divided into an upper space and a lower space in a state where the cutting portion 4 is disposed, and a mechanism for pushing down the cutting portion 4 in an emergency is disposed in the upper space. In this example, an ignition wire 8 and an explosive 9 disposed at a tip portion of the ignition wire 8 are disposed in the space above the cutting portion 4.

The reconnecting portion 5 is disposed in the second space 7. The reconnecting portion 5 is formed as a conductor, and includes a columnar foundation portion 5a having substantially the same size as the cross section of the second space 7, a first connecting portion 5b protruding upward from one end of the foundation portion 5a in the left-right direction D2, and a second connecting portion 5c protruding upward from the other end of the foundation portion 5a in the left-right direction D2.

A vertical cross section of the reconnecting portion 5 is substantially U-shaped.

The second space 7 is divided into an upper space and a lower space in a state where the reconnecting portion 5 is disposed, and a spring member 10 for biasing the reconnecting portion 5 upward is disposed in the lower space. The spring member 10 is, for example, a compression coil spring.

The reconnecting portion 5 is provided as a flange portion 5d in which a boundary portion between the foundation portion 5a, and the first connecting portion 5b and the second connecting portion 5c protrudes outward.

In the case body 2, a movement restricting portion 2b having an inwardly convex shape is formed in the vicinity of substantially the center of the vertical direction D1 of the inner peripheral surface of the second space 7.

Further upward movement of the reconnecting portion 5 disposed in the second space 7 is restricted by engagement of the flange portion 5d with the movement restricting portion 2b.

An inner surface of the reconnecting portion 5 at the first connecting portion 5b, an inner surface of the reconnecting portion 5 at the second connecting portion 5c, and a portion of the upper surface of the foundation portion 5a between the first connecting portion 5b and the second connecting portion 5c are formed as a recessed portion 5e.

An insulating portion 11 made of an insulator is attached to the recessed portion 5e.

A mechanism for pushing the reconnecting portion 5 upward is disposed in the lower space of the second space 7. In this example, an ignition wire 12 and an explosive 13 disposed at a tip portion of the ignition wire 12 are disposed in a space below the reconnecting portion 5.

The bus bar 3 includes a thick portion 3a partially located outside the case body 2, a thin portion 3b located at the center of the case body 2 in the left-right direction D2 and located immediately below the cutting tip portion 4c of the cutting portion 4, and a connecting portion 3c connecting the thick portion 3a and the thin portion 3b.

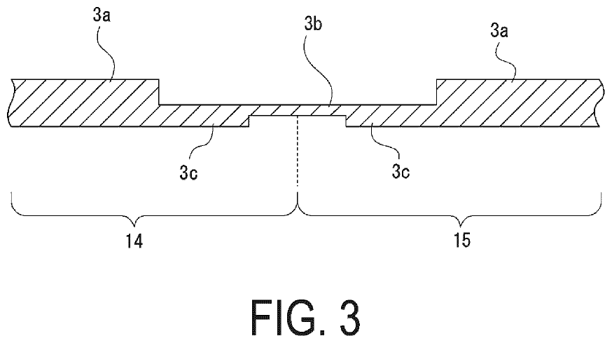

The thin portion 3b is provided as a cuttable portion that divides the bus bar 3 into the first portion 14 and the second portion 15 when the cutting portion 4 falls and collides with the bus bar 3 (see FIG. 3).

In the case body 2, a first restricting portion 16 for restricting the upward movement of the first portion 14 of the bus bar 3 in the first space 6 is formed so as to protrude inward.

Further, in the case body 2, a second restricting portion 17 that restricts upward movement of the second portion 15 of the bus bar 3 in the first space 6 is formed so as to protrude inward.

The first restricting portion 16 and the second restricting portion 17 may be integrally formed as a circumferentially continuous flange that protrudes inward in the first space 6.

### 2. Each State of Fuse Unit

In addition to the normal state illustrated in FIG. 1, the fuse unit 1 can take a disconnection state in which a part of the bus bar 3 is disconnected and the electrical connection is cut off in an emergency, and a reconnection state in which the disconnected electrical connection in the bus bar 3 is restored.

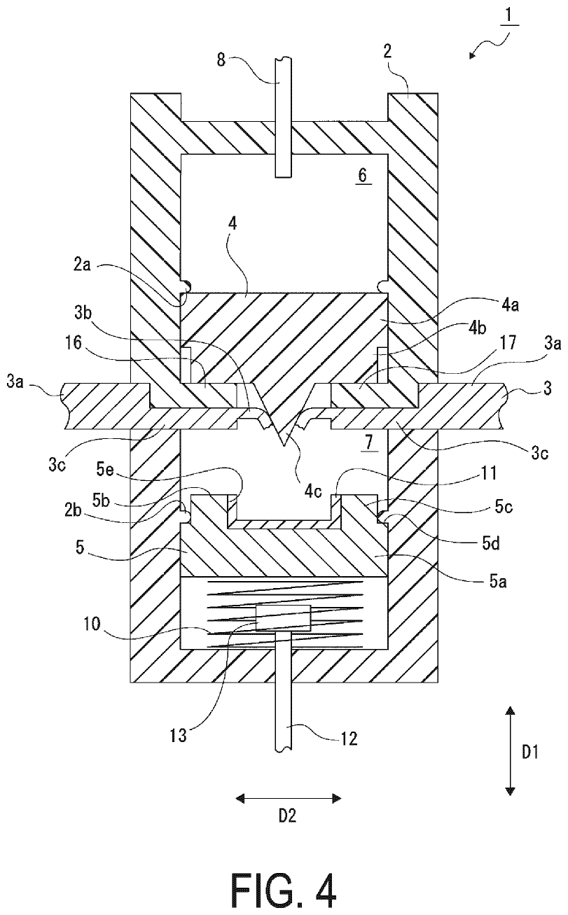

FIG. 4 illustrates an example of a disconnection state of the fuse unit 1.

When energy is applied to the explosive 9 via the ignition wire 8, the explosive 9 explodes. As a result, a strong downward force is instantaneously applied to the cutting portion 4, the large-diameter portion 4a climbs over the support protruding portion 2a, and the cutting tip portion 4c breaks through the thin portion 3b of the bus bar 3, thereby breaking the bus bar 3.

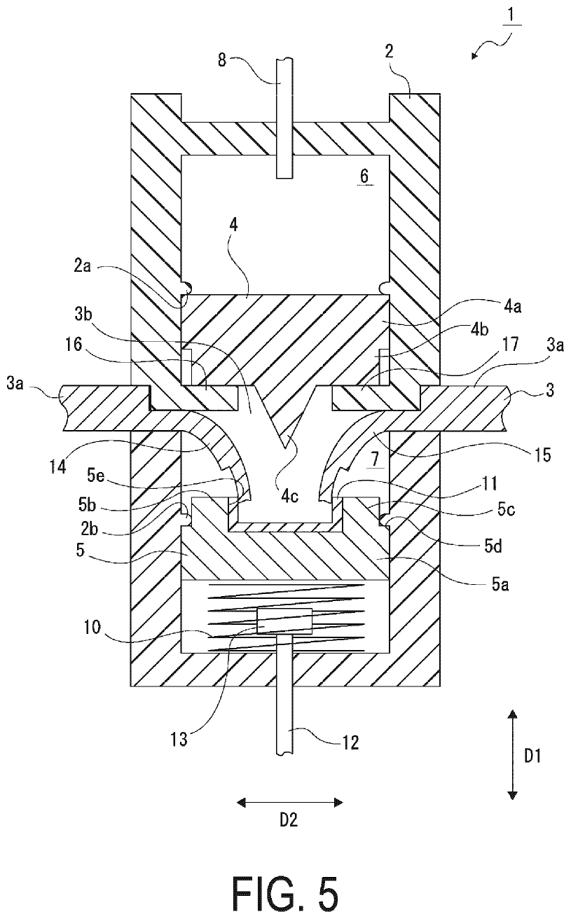

As illustrated in FIG. 5, when the bus bar 3 is broken, the tip portion of the first portion 14 and the tip portion of the second portion 15 may droop downward and come into contact with the reconnecting portion 5.

Even in such a case, since the insulating portion 11 is attached to the recessed portion 5e of the reconnecting portion 5, the electrically disconnection state between the first portion 14 and the second portion 15 is maintained.

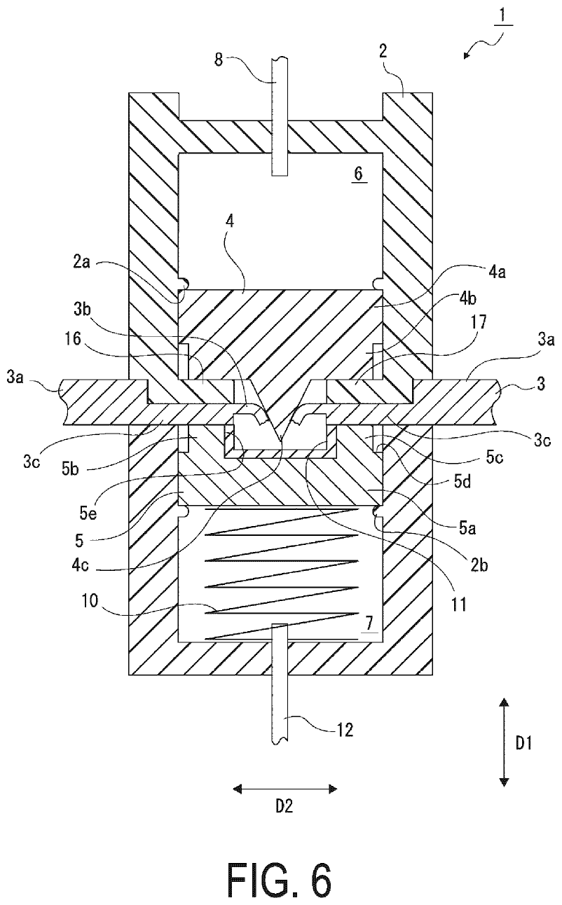

Next, an example of a reconnection state of the fuse unit 1 is illustrated in FIG. 6.

When energy is applied to the explosive 13 via the ignition wire 12, the explosive 13 explodes. As a result, a strong upward force acts on the reconnecting portion 5, the flange portion 5d climbs over the movement restricting portion 2b, the first connecting portion 5b is pressed against the first portion 14, and the second connecting portion 5c is pressed against the second portion 15.

At this time, as illustrated in the figures, since the first restricting portion 16 is provided in the case body 2, the upward movement of the first portion 14 is restricted, and the contact areas between the first connecting portion 5b and the first portion 14 are increased.

Similarly, since the second restricting portion 17 is provided in the case body 2, the upward movement of the second portion 15 is restricted, and the contact areas between the second connecting portion 5c and the second portion 15 are increased.

As a result, an increase in the junction resistance between the first connecting portion 5b and the first portion 14 and an increase in the junction resistance between the second connecting portion 5c and the second portion 15 are suppressed, and a favorable conductive state between the first portion 14 and the second portion 15 of the bus bar 3 is ensured.

As illustrated in FIG. 6, a length of the vertical direction D1 of the reconnecting portion 5 may be set such that the lower surface of the reconnecting portion 5 is supported from below by the movement restricting portion 2b in a state where the first connecting portion 5b and the second connecting portion 5c are pressed against the first portion 14 and the second portion 15, respectively.

This makes it easy to maintain a state in which the first connecting portion 5b and the second connecting portion 5c are strongly pressed against the first portion 14 and the second portion 15, respectively.

### 3. Modification

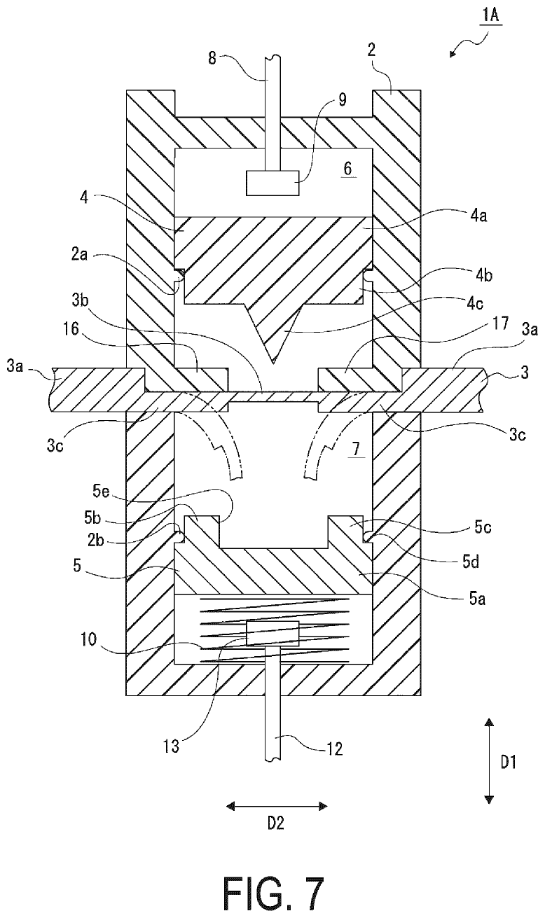

A first example of the modification is illustrated in FIG. 7.

In a fuse unit 1A of this example, the insulating portion 11 is not provided on the recessed portion 5e of the reconnecting portion 5.

The reconnecting portion 5 in the present modification is disposed below the bus bar 3 at a distance from the bus bar 3 to such an extent that even if the tip portions of the first portion 14 and the second portion 15 which have been broken as illustrated in FIG. 5 droop downward (indicated by a two dot chain line in FIG. 7), they do not reach the bus bar 3.

Accordingly, in the disconnection state of the fuse unit 1A, the first portion 14 and the second portion 15 are prevented from being electrically connected to each other via the reconnecting portion 5.

Further, since the insulating portion 11 is not provided, the number of components can be reduced.

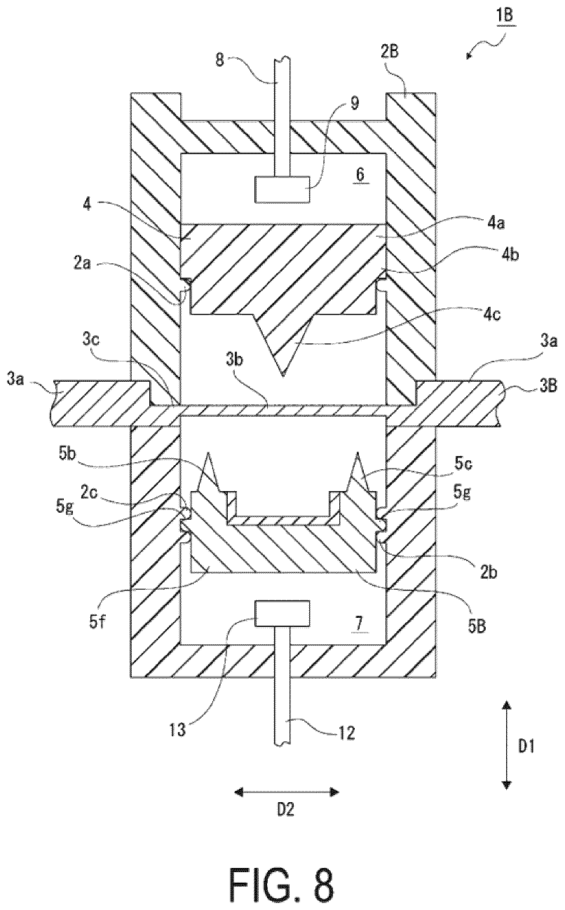

A second example of the modification is illustrated in FIG. 8.

A fuse unit 1B according to the present modification is different from the above-described example in a shape of a case body 2B, a shape of a bus bar 3B, and a shape of a reconnecting portion 5B.

First, the bus bar 3B includes the thick portion 3a, the thin portion 3b, and the connecting portion 3c, but a portion disposed in the first space 6 and the second space 7 is the substantially thin portion 3b.

The reconnecting portion 5B disposed in the second space 7 below the bus bar 3B includes a columnar base portion 5f, the first connecting portion 5b protruding upward from the vicinity of one end of the base portion 5f in the left-right direction D2 and having a conical tip portion, and the second connecting portion 5c protruding upward from the vicinity of the other end of the base portion 5f in the left-right direction D2 and having a conical tip portion.

An upper portion of the base portion 5f is formed as a protrusion engaging portion 5g that protrudes at least in the left-right direction D2.

Since the protrusion engaging portion 5g is located above the movement restricting portion 2b of the case body 2B, downward movement (for example, movement due to gravity) of the reconnecting portion 5B is restricted.

Unlike the other examples described above, an upward force is not applied to the reconnecting portion 5B by the spring member 10 or the like.

Further, a second movement restricting portion 2c for restricting upward movement of the reconnecting portion 5B is formed slightly above the portion of the inner peripheral surface of the second space 7 of the case body 2B with which the protrusion engaging portion 5g is in contact.

That is, the reconnecting portion 5B is held in a state where the protrusion engaging portion 5g is sandwiched between the movement restricting portion 2b and the second movement restricting portion 2c, so that the movement of the reconnecting portion 5B in the vertical direction D1 is restricted.

The case body 2B is not provided with the first restricting portion 16 that restricts the upward movement of the first portion 14 of the bus bar 3B and the second restricting portion 17 that restricts the upward movement of the second portion 15.

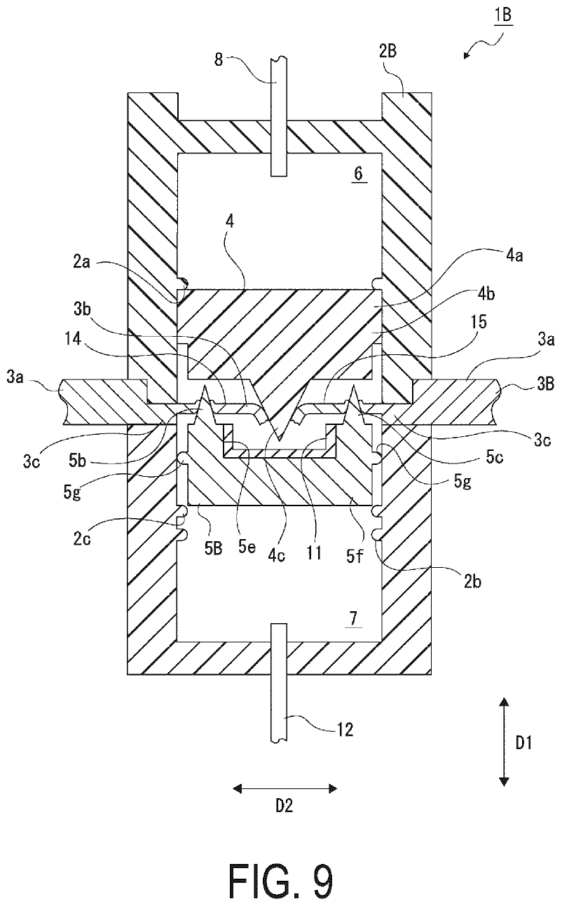

FIG. 9 illustrates a reconnection state of the fuse unit 1B in this modification.

As illustrated in the figure, when the reconnecting portion 5B is strongly moved upward by exploding the explosive 13 via the ignition wire 12, the first connecting portion 5b of the reconnecting portion 5B penetrates the first portion 14 of the broken bus bar 3B, and the second connecting portion 5c penetrates the second portion 15.

Since the tip portions of the first connecting portion 5b and the second connecting portion 5c have a conical shape, the first connecting portion 5b and the second connecting portion 5c can easily penetrate through the first portion 14 and the second portion 15.

In the first connecting portion 5b and the second connecting portion 5c, a return may be provided so that a state of penetrating the first portion 14 and the second portion 15 is easily maintained.

Further, in order to make it easy for the first connecting portion 5b and the second connecting portion 5c to penetrate the first portion 14 and the second portion 15, respectively, a restricting portion for restricting upward movement of the first portion 14 and the second portion 15 may be provided.

It is desirable that the restricting portion is provided so as not to interfere with the tip portion of the first connecting portion 5b and the tip portion of the second connecting portion 5c in a penetrating state.

Further, in order to prevent the first connecting portion 5b and the second connecting portion 5c from interfering with the cutting portion 4 that has fallen from above, a retraction hole may be formed in the cutting portion 4 to allow the tip portion of the first connecting portion 5b that has passed through the first portion 14 to escape.

Similarly, a retraction hole may be formed in the cutting portion 4 to allow the tip portion of the second connecting portion 5c that has passed through the second portion 15 to escape.

Further, in order to prevent excessive downward movement of the cutting portion 4, for example, in order to prevent downward movement of the cutting portion 4 to such an extent as to hinder upward movement of the reconnecting portion 5 after the bus bar 3 is cut, a restricting portion may be provided on the inner peripheral surface of the first space 6 of the case body 2B.

According to this modification, since the first restricting portion 16 and the second restricting portion 17, the spring member 10, and the like are not provided on the case body 2B, the weight of the fuse unit 1B is reduced.

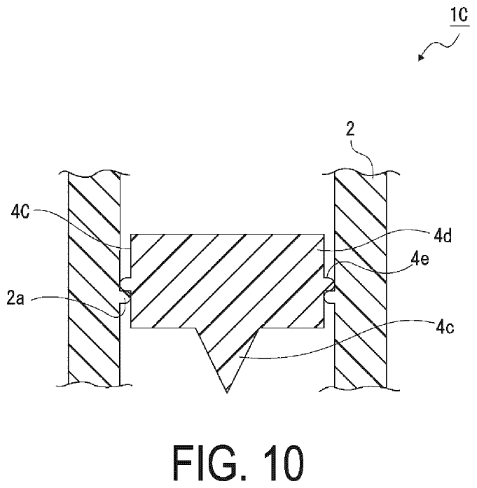

A third example of the modification is illustrated in FIG. 10.

A fuse unit 1C according to the present modification is different from the example described above in the shape of a cutting portion 4C.

In one example, the cutting portion 4C does not include the large-diameter portion 4a and the small-diameter portion 4b, but includes a cylindrical portion 4d, a protruding portion 4e protruding outward substantially at the center of the cylindrical portion 4d in the vertical direction D1, and the cutting tip portion 4c.

Since the large-diameter portion 4a having substantially the same radius as that of the first space 6 is not provided, the frictional resistance between the cutting portion 4 and the case body 2 is minimized after the protruding portion 4e moves over the support protruding portion 2a and is located below the support protruding portion 2a in the transition process from the normal state to the disconnection state.

Therefore, the bus bar 3 can be broken by the cutting tip portion 4c of the cutting portion 4 with a smaller amount of the explosive 9.

The same configuration can also be applied to the reconnecting portion 5.

In each of the above-described examples, an example in which the spring member 10 as a compression spring is used below the reconnecting portion 5 is described, but a spring member as a tension spring may be provided above the reconnecting portion 5. In this case, the movement restricting portion 2b of the case body 2 is provided at a position and in a shape so as to restrict the upward movement of the reconnecting portion 5.

### 4. CONCLUSION

As described in each of the above examples, the fuse unit 1 (1A, 1B, 1C) according to the disclosure includes the bus bar 3 (3B) made of a conductor and provided with the cuttable portion (thin portion 3b), the case body 2 (2B) which supports two points sandwiching the cuttable portion, the cutting portion 4 (4C) made of an insulator, the cutting portion 4 (4C) being disposed in the first space 6 that is the internal space of the case body 2 (2B) and is formed on one side of the bus bar 3 (3B), and the reconnecting portion 5 (5B) made of a conductor, the reconnecting portion 5 (5B) being disposed in a second space 7 that is the internal space of the case body 2 (2B) and is formed on a side of the bus bar 3 (3B) opposite to the first space 6.

In addition, the cutting portion 4 (4C) has a cutting tip portion 4c that cuts the bus bar 3 (3B) into the first portion 14 and the second portion 15 at the cuttable portion and is movable into the second space 7.

The reconnecting portion 5 (5B) has a first connecting portion 5b in contact with the first portion 14 and a second connecting portion 5c in contact with the second portion 15.

Accordingly, after the bus bar 3 (3B) is cut by the cutting portion 4 (4C) and the electrical connection between the first portion 14 and the second portion 15 is cut off, the electrical connection between the first portion 14 and the second portion 15 is established again by the reconnecting portion 5 (5B).

For example, by applying the fuse unit 1 (1A, 1B, 1C) of the disclosure to vehicles, after the bus bar 3 (3B) is cut in order to avoid secondary damage due to electric leakage at the time of occurrence of a fault, the electrical connection of the bus bar 3 (3B) is restored, and thus it is possible to move the vehicles in order to secure the security of the fault site.

In addition, under extremely low temperatures, it is conceivable to stay inside the vehicle in which the accident has occurred and wait for a rescue while warming up. However, by restoring the electrical connection of the bus bar 3 (3B), it is possible to perform air conditioning inside the vehicle using the electric power of the in-vehicle battery, and it is possible to improve the survivability of the vehicle occupants.

The reconnecting portion 5 (5B) in the fuse unit 1 (1B, 1C) according to the disclosure may have a U-shape in which the first connecting portion 5b and the second connecting portion 5c are formed in a protruding shape toward the bus bar 3 (3B), and the insulating portion 11 may be provided in the recessed portion 5e of the U-shape in the reconnecting portion 5 (5B).

As a result, even if both of the tip portions of the first portion 14 and the second portion 15 of the broken bus bar 3 (3B) come into contact with the reconnecting portion 5 (5B), the portion with which both of the tip portions come into contact is the insulating portion 11. Therefore, unintended restoration of the electrical connection between the first portion 14 and the second portion 15 can be prevented, and safety can be improved.

In addition, since the insulating portion 11 is provided on the recessed portion 5e and is not provided on the tip portions of the first connecting portion 5b and the second connecting portion 5c, it is possible to prevent the restoration of the electrical connection between the first portion 14 and the second portion 15 from being inhibited.

The case body 2 in the fuse unit 1 (1A, 1C) according to the disclosure may include the first restricting portion 16 that restricts movement of the first portion 14 toward the first space 6, and the second restricting portion 17 that restricts movement of the second portion 15 toward the first space 6.

As a result, when the first connecting portion 5b and the second connecting portion 5c are pressed against the first portion 14 and the second portion 15, respectively, the movement of the first portion 14 and the second portion 15 toward the first space 6 is restricted, and a favorable connection state is ensured.

Therefore, the electrical connection between the first portion 14 and the second portion 15 can be suitably recovered.

In addition, the contact areas between the first portion 14 and the first connecting portion 5b and between the second portion 15 and the second connecting portion 5c can be increased, the increase in the contact resistance can be suppressed, and the power consumption can be reduced.

The fuse unit 1 (1A, 1C) according to the disclosure may include the spring member 10 that biases the reconnecting portion 5 in the direction toward the bus bar 3, and the case body 2 may include the movement restricting portion 2b that restricts the movement of the reconnecting portion 5 in the direction toward the bus bar 3.

Thus, the first connecting portion 5b and the second connecting portion 5c of the reconnecting portion 5 are pressed against the first portion 14 and the second portion 15, respectively, by simply releasing the restriction by the movement restricting portion 2b, and the electrical connection between the first portion 14 and the second portion 15 is restored.

Therefore, no motor driving or the like for bringing the first connecting portion 5b and the second connecting portion 5c into contact with the first portion 14 and the second portion 15, respectively, at the time of reconnection is to be used.

Various forms of the movement restricting portion 2b can be considered. For example, the movement restricting portion 2b may be configured to be able to change between a state of protruding from the inside wall of the case body 2 and a state of being housed in the inside wall of the case body 2. In this case, it is not necessary to dispose the explosive 13 below the reconnecting portion 5, which can contribute to improvement in safety.

The spring member 10 in the fuse unit 1 (1A, 1C) according to the disclosure may bias the reconnecting portion 5 in a direction approaching the bus bar 3 (3B) in a state where the first connecting portion 5b is in contact with the first portion 14 and the second connecting portion 5c is in contact with the second portion 15.

Thus, after the reconnection, the state in which the first connecting portion 5b is pressed against the first portion 14 and the second connecting portion 5c is pressed against the second portion 15 continues.

Therefore, it is possible to continuously secure the electrical connection between the first portion 14 and the second portion 15 after the reconnection.

The above-described embodiments and modifications can be combined as appropriate. According to the fuse unit of the disclosure, it is possible to release and restore electrical connection with a simple configuration.

1. A fuse unit comprising:
a bus bar made of a conductor and provided with a cuttable portion;
a case body supporting two points sandwiching the cuttable portion;
a cutting portion made of an insulator, the cutting portion being disposed in a first space, the first space being provided in an internal space of the case body on one side with respect to the bus bar; and
a reconnecting portion made of a conductor, the reconnecting portion being disposed in a second space, the second space being provided in the internal space of the case body on a side of the bus bar opposite to the first space, wherein
the cutting portion includes a tip portion configured to cut the bus bar into a first portion and a second portion at the cuttable portion, the tip portion being movable into the second space, and
the reconnecting portion includes a first connecting portion in contact with the first portion and a second connecting portion in contact with the second portion.

2. The fuse unit according to claim 1, wherein
the reconnecting portion has a U-shape in which the first connecting portion and the second connecting portion are provided so to protrude toward the bus bar, and
an insulating portion is provided in a recessed portion of the U-shape of the reconnecting portion.

3. The fuse unit according to claim 1, wherein
the case body includes a first restricting portion configured to restrict movement of the first portion toward the first space, and a second restricting portion configured to restrict movement of the second portion toward the first space.

4. The fuse unit according to claim 1, further comprising a spring member configured to bias the reconnecting portion in a direction approaching the bus bar, wherein
the case body includes a movement restricting portion configured to restrict movement of the reconnecting portion in the direction approaching the bus bar.

5. The fuse unit according to claim 4, wherein
the spring member is configured to bias the reconnecting portion in the direction approaching the bus bar in a state where the first connecting portion is in contact with the first portion and the second connecting portion is in contact with the second portion.
